(19) United States
(12) Patent Application Publication
(10) Pub. No.: US 2025/0330393 A1
(43) Pub. Date: Oct. 23, 2025

(54) APPLICATION-SPECIFIC SLA THRESHOLDS FOR SD-WAN APPLICATION AWARE ROUTING

(71) Applicant: Cisco Technology, Inc., San Jose, CA (US)

(72) Inventors: Syed Arslan Ahmed, Bengaluru (IN); Ankur Bhargava, Pleasanton, CA (US); Ashish Sood, Cupertino, CA (US); Amjad Inamdar, Bengaluru (IN); Raj Venkatesan, Mill Valley, CA (US)

(21) Appl. No.: 18/639,896

(22) Filed: Apr. 18, 2024

(51) Int. Cl. H04L 41/5003; H04L 47/24

(52) U.S. Cl. CPC H04L 41/5003; H04L 47/24

(57) ABSTRACT

This disclosure describes techniques for routing application traffic on a network path based on an application-specific Service Level Agreement (SLA) threshold that may be dynamically and/or automatically determined. An edge device of an SD-WAN may send probes over the SD-WAN over multiple paths and may determine network telemetry data representing the network performance associated with the multiple paths. The edge device may then send the network telemetry data to a control plane. The control plane may also receive quality of experience (QoE) data indicating the quality of an application experience for a user. Based on the network telemetry data and the QoE data, an application-specific SLA threshold may be determined for the application. The edge device may then route traffic of the application through a path of the multiple paths based at least in part on the path satisfying the SLA threshold.

### TECHNICAL FIELD

The present disclosure relates generally to the field of computer networking, and more particularly to dynamically learning application service level agreements (SLAs) to route application traffic in SD-WANs.

### BACKGROUND

Computer networks are generally a group of computers or other devices that are communicatively connected to use one or more communication protocols to exchange data. For instance, computer networking can refer to connected computing devices (such as laptops, desktops, servers, smartphones, and tablets) as well as an ever-expanding array of Internet-of-Things (IoT) devices (such as cameras, door locks, doorbells, refrigerators, audio/visual systems, thermostats, and various sensors) that communicate with one another. Modern-day networks deliver various types of networks, such as Local-Area Networks (LANs) that are in one physical location such as a building, Wide-Area Networks (WANs) that extend over a large geographic area to connect individual users or LANs Enterprise Networks that are built for a large organization, Internet Service Provider (ISP) networks that operate WANs to provide connectivity to individual users or enterprises, software-defined networks (SDNs), wireless networks, core networks, cloud networks, software-defined WANs (SD-WANs), and so forth.

In SD-WANs, a service-level agreement (SLA) may be used to determine tunnels through which to send application traffic by matching performance attributes of a tunnel with an application SLA such that the SLA may be satisfied. For example, an SLA may define maximum jitter, maximum latency, maximum packet loss, and/or the like. In order for customers to decide the SLAs for their applications, the customers may receive SLA thresholds from the publishers of the application. In instances where applications may be enterprise applications, SLA thresholds may be determined by the enterprise such as by performing tests to look at the network conditions in which their applications behave well in. However, SLAs may be applied generically across multiple groups of applications and/or multiple applications within the same traffic class. Additionally, applications may evolve and/or adapt, and the static nature of SLA values may in turn lead to the SLA thresholds to be overly aggressive or too lenient and may be non-representative of what the actual requirements of the applications and/or the actual experience of the users associated with the applications.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an example environment for routing application traffic based on an application-specific SLA threshold, according to at least some examples.

FIG. 2 illustrates a diagram of components the system of FIG. 1 that identify application-specific SLA thresholds and routes application traffic based on the application-specific SLA, according to at least some examples.

FIG. 3 illustrates an example environment in which an SLA threshold service determines application-specific SLAs, according to at least some examples.

FIG. 4 illustrates a flow diagram of an example method for collecting network telemetry data and routing application traffic based on an application-specific SLA, according to at least some examples.

FIG. 5 illustrates a flow diagram of an example method for determining application-specific SLA thresholds, according to at least some examples.

FIG. 6 illustrates a computing system diagram illustrating a configuration for a data center that can be utilized to implement aspects of the technologies disclosed herein.

FIG. 7 is a computer architecture diagram showing an illustrative computer hardware architecture for implementing a computing device that can be utilized to implement aspects of the various technologies presented herein.

### DESCRIPTION OF EXAMPLE EMBODIMENTS

### Overview

This disclosure describes techniques for routing application traffic based on application-specific SLA thresholds. A method to perform the techniques described herein at least in part by an edge device include sending, from the edge device, probes over an SD-WAN over multiple paths. Additionally, or alternatively, the method includes determining, based at least in part on the probes, network telemetry data representing network performance associated with the multiple paths. Further, the method includes sending, from the edge device, network telemetry data to a control plane. The method may further include receiving a policy that indicates a first threshold Service Level Agreement (SLA) that is suitable for a first application for sending traffic via the multiple paths over the SD-WAN. Further, the method may include routing traffic from the first application through a first path of the multiple paths based at least in part on the first path satisfying the first threshold SLA.

Additionally, or alternatively, the method includes receiving, from an edge device, network telemetry data representing network performance associated with multiple paths of an SD-WAN. Further, the method includes receiving quality of experience data indicating a quality of application experience. Additionally, or alternatively, the method includes determining, based at least in part on the network telemetry data and the quality of experience data, a first threshold Service Level Agreement (SLA) that is suitable for a first application for sending traffic via the multiple paths over the SD-WAN. The method further includes generating, based at least in part on the first threshold SLA, a policy that indicates the first threshold SLA that is suitable for the first application. Additionally, or alternatively, the method includes sending the policy to the edge device.

Additionally, the techniques described herein may be performed by a system and/or device having non-transitory computer-readable media storing computer-executable instructions that, when executed by one or more processors, performs the method described above.

### Example Embodiments

This disclosure describes techniques for routing application traffic based on application-specific SLA thresholds. As discussed above, there are a number of limitations in the use of SLA thresholds for routing application traffic. Traditionally, users may obtain SLA thresholds for their applications from publishers of the applications. The SLA thresholds may be applied generically across multiple groups of applications and/or multiple applications within the same traffic class. However, applications may evolve and/or adapt, and the traditionally static nature of SLA values may in turn lead to the SLA thresholds being overly aggressive or too lenient, and may be non-representative of the actual requirements of the applications.

According to the techniques described herein, one or more network devices, such as a network edge device, associated with a network, such as an SD-WAN, may monitor performance metrics of the network and send the performance metrics as telemetry data associated with one or more paths of the network to a controller of the network. In some instances, the network edge device may be communicatively coupled the controller to send the telemetry data associated with the network to the controller. The network edge device may send telemetry data periodically or continuously. In some instances, the network may include multiple paths for sending application traffic, and the network edge device may send probes (i.e., synthetic traffic injected along with real network traffic) through the multiple paths in order to collect performance metrics associated with the multiple paths. For example, the probes may measure round-trip time (RTT) between the network edge device and another network device. Additionally, or alternatively, the probes may measure time to live (TTL) data between the network edge device and another network device. In some instances, the performance metrics may include a representation of traffic loss due to bandwidth constraints, latency, and jitter associated with each of the multiple paths. In some instances, the network edge device may passively monitor the multiple paths of the network to collect performance metrics associated with the multiple paths. For example, the network edge device may send probes in response to the controller receiving instructions from a user and/or enterprise for defining an SLA for the application associated with the user.

To implement the techniques described herein, the controller may use, or work in combination with, a third-party service provider in order to receive quality of experience data (QoE) associated with an application. The controller may receive QoE data directly from the third-party service provider and/or a user of the third-party service provider. For example, a user may provide to the third-party service user input indicating a QoE at various instances (e.g., user input indicating the QoE, such as buffering and/or video resolution, after concluding a video call, where the application is web conferencing application). In another example, the user may provide to the third-party service user input indicating the QoE, where the QoE is audio quality after concluding a voice call. The user input may be a response to a rating, feedback, survey, and/or the like. Additionally, or alternatively, the controller may establish connections (e.g., application programming interface (API) calls) with an application. For example, the controller may expose the application interface, and in turn extract QoE data (e.g., indications of response times associated with the application). For example, the controller may expose the application interface and extra QoE data such as resolution, buffering time, and/or the like.

In some instances, an SLA threshold service associated with the controller may determine, based on the telemetry data and/or the QoE data, an SLA threshold that is specific to the application associated with the user. In some instances, the telemetry data and/or the QoE data may indicate the performance requirements and/or necessities for the application associated with the user. Additionally, or alternatively, the SLA threshold may be specific to the user device on which the application is running, and/or the site of the application. Additionally, or alternatively, the SLA threshold for an application may be provided as an initial recommendation to a user in response to user instructions for defining the SLA for the application. In some instances, the SLA threshold for an application may be periodically or continuously updated based on changes in network performance metrics, and in turn, changes in telemetry data. Additionally, or alternatively, the SLA threshold for the application may be periodically or continuously updated based on changes in the QoE data. The SLA threshold for the application may be periodically or continuously updated based on changes in the requirements and/or necessities for the application.

Upon the determination of the SLA threshold that is specific to the application, the controller may be configured to generate an application-aware routing (AAR) policy for routing traffic from the application. For example, the SLA threshold specific to the application may indicate a latency threshold of 100 milliseconds for traffic to be delivered. Additionally, or alternatively, the SLA threshold specific to the application may indicate a jitter threshold of 50 milliseconds. Additionally, or alternatively, the SLA threshold specific to the application may indicate a packet loss threshold of 0.1%. In some instances, the SLA threshold specific to the application may also include thresholds related to throughput, failover, and/or remedies in instances where an SLA threshold is violated. The policy indicating the SLA threshold specific to the application may be pushed to the network edge device such that the policy may be enforced and traffic from the application may be sent through a path in accordance with the SLA threshold. For example, the network edge device may be configured to identify a path from multiple paths associated with the SD-WAN to route application traffic through, where routing application traffic through the path complies with the performance metrics indicated by the SLA threshold. Additionally, or alternatively, in instances where the SLA threshold may be updated based on changes in the network performance metrics and/or QoE data, an updated policy may also be pushed to the network edge device such that the updated policy may be enforced and traffic from the application may be sent through a path in accordance with the updated SLA threshold.

Although the techniques are described as being implemented using a cloud service, including computing servers, data centers, and/or a cloud computing network, the techniques are generally applicable for any network of devices managed by an entity where virtual resources may be provisioned. In some instances, various components may be used in a system to perform the techniques described herein. The devices and components by which the techniques are performed are a matter of implementation, and the techniques described are not limited to any specific architecture or implementation.

The techniques described herein provide various improvements and efficiencies with respect to using a cloud service to compute application-specific SLA thresholds using dynamic telemetry data associated with an SD-WAN in combination with QoE data. For example, the techniques described herein may allow for the determination of one or more paths for sending application traffic based on an application-specific SLA threshold. The techniques may allow for the probing of multiple paths for sending application traffic in an SD-WAN to determine performance metrics of the multiple paths. An SLA threshold may be determined by correlating telemetry data of the SD-WAN (e.g., loss, latency, jitter, etc.) to QoE data at a given point in time and for a given application, where the SLA threshold is specific to an application and/or any application context (e.g., site associated with the application, user device associated with the application, and/or the like). The SLA threshold may be dynamically updated as network conditions change and/or the application changes.

Certain implementations and embodiments of the disclosure will now be described more fully with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

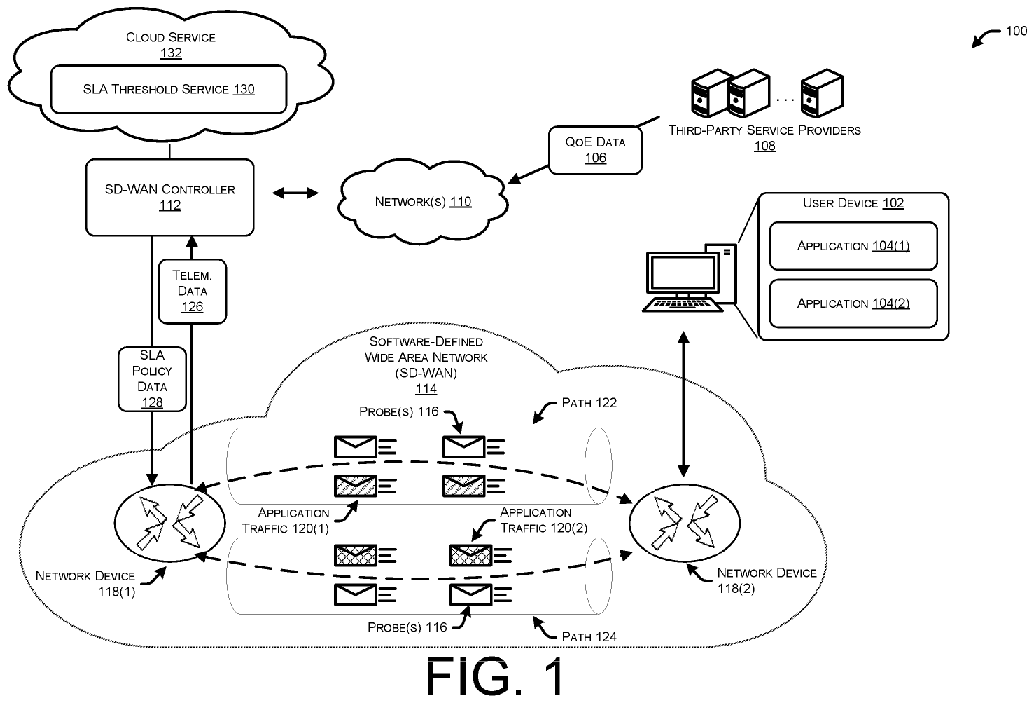

FIG. 1 illustrates a system-architecture diagram of an example environment 100 for routing application traffic based on an application-specific SLA threshold, according to at least some examples. The environment 100 includes an SD-WAN controller for receiving telemetry data 126 and quality of experience (QoE) data 106, and a cloud service 132 for computing an application-specific SLA threshold. This way, network device(s) 118 may determine a path for application traffic 120, for example, from network device 118(1) to network device 118(2).

The cloud service 132 may comprise one or more components, subcomponents, and/or configurations. For example, the cloud service 132 may include SLA threshold service 130, which may be configured to determine application-specific SLA thresholds. In some examples, the cloud service 132 may be or comprise a cloud provider network. A cloud provider network (sometimes referred to simply as a “cloud”) refers to a pool of network-accessible computing resources (such as compute, storage, and networking resources, applications, and services), which may be virtualized or bare-metal. The cloud can provide convenient, on-demand network access to a shared pool of configurable computing resources that can be programmatically provisioned and released in response to user commands. In other instances, however, the cloud service 132 may be an on-premises network, a private network of a corporation, and/or any other type of network or combination thereof.

In some instances, SLA threshold service 130 may be a scalable service that includes and/or runs on devices housed or located in one or more data centers and may be located at different physical locations. In some examples, the SLA threshold service 130 may be supported by networks of devices in a public cloud computing platform, a private/enterprise computing platform, and/or any combination thereof. The one or more data centers may be physical facilities or buildings located across geographic areas that are designated to store network devices that are part of and/or support the SLA threshold service 130. The data centers may include various networking devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs. Generally, the data centers (physical and/or virtual) may provide basic resources such as process (CPU), memory (RAM), storage (disk), and networking (bandwidth).

The cloud service 132 may provide one or more SLA threshold determination services to users of user device 102 for sending application traffic of applications 104 associated with the user device 102. The user device 102 may be configured to communicate over one or more SD-WANs 114. As illustrated, the user device 102 may include a device associated with one or more applications 104, such as applications 104(1) and/or 104(2). The user device 102 may comprise any type of electronic device capable of communicating using various communication protocols (e.g., short range protocols, TCP/IP, User Datagram Protocol (UDP), tunneling protocols, and/or any other protocol) over various networks. For instance, the user device 102 may include one or more of different personal user devices, such as desktop computers, laptop computers, phones, tablets, wearable devices, entertainment devices such as televisions, and/or any other type of computing device.

The SD-WAN 114 may include one or more networks implemented by any viable communication technology, such as wired and/or wireless modalities and/or technologies. The SD-WAN 114 may include or connect any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The SD-WAN may include devices, such as network devices 118, virtual resources, or other nodes that relay traffic from one network segment to another by nodes in the computer network.

As illustrated, the SD-WAN 114 may include network device 118(1) and/or 118(2) that may be associated with the user device 102. In some instances, the network device 118(1) and/or network device 118(2) may be configured to route application traffic 120 on behalf of the user device 102. A network edge device, such as network device 118(1), may be configured to monitor performance metrics of the SD-WAN 114 and send the performance metrics as telemetry data 126. The telemetry data 126 may indicate performance metrics for path 122 and/or path 124. In some instances, the network device 118(1) may be configured to send the telemetry data 126 to the SD-WAN controller 112. The network device 118(1) may send telemetry data 126 periodically or continuously. In some instances, the SD-WAN 114 may include multiple paths for sending traffic for applications, such as application 104(1) and/or 104(2). For example, SD-WAN 114 may include path 122 and/or path 124. The network device 118(1) may send probes, such as probe(s) 116 through path 122 and/or path 124 in order to collect the performance metrics associated with path 122 and/or path 124, respectively. For example, probe(s) 116 may be sent between network device 118(1) and network device 118(2) via path 122 and/or path 124. For example, based on the probe(s) 116, network device 118(1) may determine performance metrics such as traffic loss due to bandwidth constraints, latency in the SD-WAN 114, and/or jitter. In some instances, the network device 118(1) may passively monitor paths 122 and/or path 124 with probe(s) 116 to collect performance metrics associated with path 122 and/or path 124. For example, the network device 118(1) may send probe(s) 116 in response to the SD-WAN controller 112 receiving instructions from user device 102 for defining an SLA for an application associated with the user device 102, such as application 104(1) and/or application 104(2). After network device 118(1) has sent probe(s) 116 and has collected performance metrics associated with the path 122 and/or path 124, the network device 118(1) may be configured to send the performance metrics as telemetry data 126 to the SD-WAN controller 112.

In some instances, the SD-WAN controller 112 may also receive QoE data 106 from third-party service providers 108. As illustrated, third-party service providers 108 may be configured to communicate with the SD-WAN controller 112 via network(s) 110. The SD-WAN controller 112 may receive QoE data 106 directly from third-party service providers 108 and/or a user of the third-party service associated with the application. For example, a user associated with application 104(1) and/or application 104(2) may provide to the third-party service provider 108 user input indicating a QoE at various instances, where the third-party service provider 108 may be associated with application 104(1) and/or application 104(2). For example, a user may provide user input and/or feedback indicating the QoE after concluding a video call, where the application 104(1) is a web conferencing application. In another example, the user may provide user input and/or feedback indicating after sending an email, where the application 104(2) is a messaging application. Additionally, or alternatively, the SD-WAN controller 112 may establish connections (e.g., application programming interface (API) calls) with application 104(1) and/or application 104(2). For example, the SD-WAN controller 112 may expose the application interface, and in turn extract QoE data 106 (e.g., indications of response times associated with application 104(1) and/or application 104(2)).

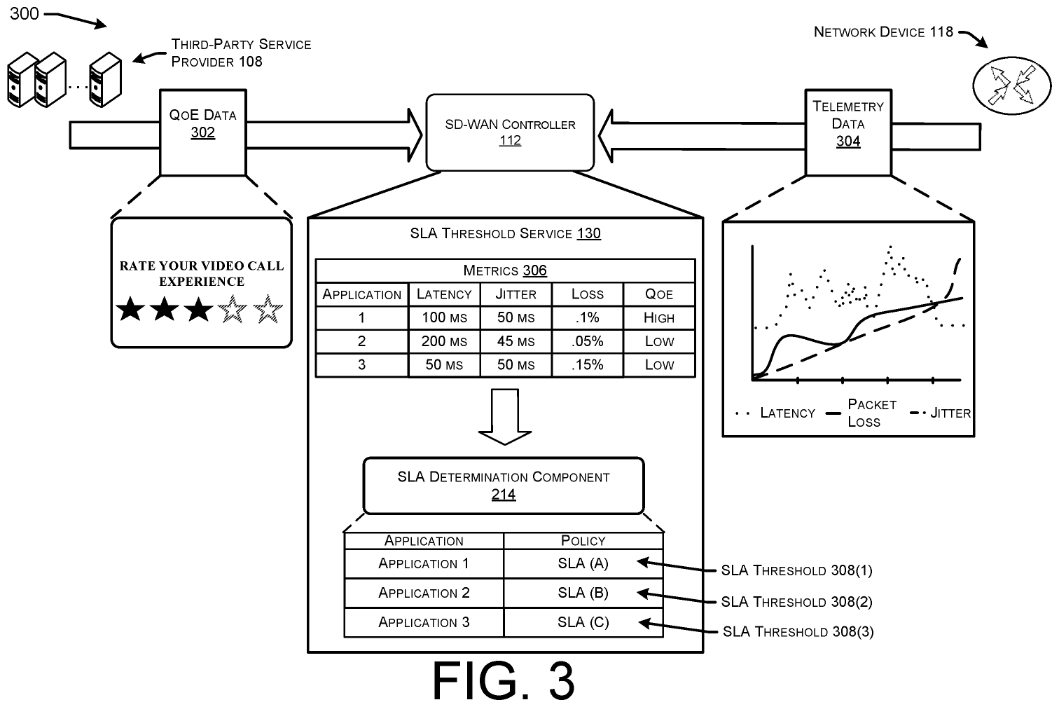

As described in more detail below with respect to FIG. 3, the SD-WAN controller 112 may use, or work in conjunction with, SLA threshold service 130 in order to determine an SLA threshold that is specific to an application, such as an SLA threshold that is specific to application 104(1) and/or an SLA threshold that is specific to application 104(2). Additionally, or alternatively, the SLA threshold may be specific to the user device 102 on which the application 104(1) and/or 104(2) is running, and/or the site of the application 104(1) and/or application 104(2). The SLA threshold may be determined by correlating the telemetry data 126 with QoE data 106 at a particular point in time for a particular application. Additionally, or alternatively, the SLA threshold for an application may be provided as an initial recommendation to a user in response to user instructions for defining the SLA for the application. In some instances, the SLA threshold for an application may be periodically or continuously updated based on changes in network performance metrics indicated by probe(s) 116, and in turn, changes in telemetry data 126. Additionally, or alternatively, the SLA threshold for an application may be periodically or continuously updated based on changes in the QoE data 106.

Upon the determination of the SLA threshold that is specific to an application (e.g., a SLA threshold for application 104(1) and/or a different SLA threshold for application 104(2)) by the SLA threshold service 130, the SD-WAN controller 112 may be configured to generate an application-aware routing (AAR) policy for routing application traffic 120(1) and/or application traffic 120(2) for application 104(1) and/or application 104(2), respectively. The policy may be pushed to the network device 118(1) such that the policy may be enforced and application traffic 120(1) and/or application traffic 120(2) may be sent through path 122 and/or 124 in accordance with their respective SLA threshold.

For example, based on telemetry data 126 and/or QoE data 106, the SLA threshold service 130 may determine an SLA threshold that is optimized for communicating application traffic 120(1) from application 104(1). Based on the SLA threshold for application 104(1), the SD-WAN controller 112 may push SLA policy data 128 to the network device 118(1) indicating the SLA threshold for application 104(1). Based on the SLA threshold for application 104(1), the network device 118(1) may determine that path 122 would satisfy the SLA threshold for application 104(1). Accordingly, the network device 118(1) may send application traffic 120(1) associated with application 104(1) over path 122.

Additionally, or alternatively, based on telemetry data 126 and/or QoE data 106, the SLA threshold service 130 may determine a different SLA threshold that is optimized for communicating application traffic 120(2) from application 104(2). Based on the SLA threshold for application 104(2), the SD-WAN controller 112 may push SLA policy data 128 to the network device 118(1) and/or network device 118(2) indicating the SLA threshold for application 104(2). Based on the SLA threshold for application 104(2), the network device 118(1) and/or network device 118(2) may determine that path 124 would satisfy the SLA threshold for application 104(2). Accordingly, the network device 118(1) and/or 118(2) may send application traffic 120(2) associated with application 104(2) over path 124. Additionally, or alternatively, in instances where the SLA threshold may be updated based on changes in the telemetry data 126 and/or QoE data, updated SLA policy data 128 may be pushed to the network device 118(1) and/or 118(2) such that the updated policy may be enforced and traffic from the application may be sent through a path in accordance with the updated SLA threshold. For example, based on SLA policy data 128, network device 118(1) may send application traffic 120(1) associated with application 104(1) over path 122 based on the SLA threshold associated with application 104(1). Additionally, or alternatively, telemetry data 126 and/or QoE data 106 may change, and as such, the SLA threshold service 130 may determine an updated SLA threshold for application 104(1), and push updated SLA policy data 128 to the network device 118(1). In such instances, the network device 118(1) may cause the application traffic 120(1) to be sent through path 124 instead of path 122 based on the path 122 no longer being able to satisfy the updated SLA value.

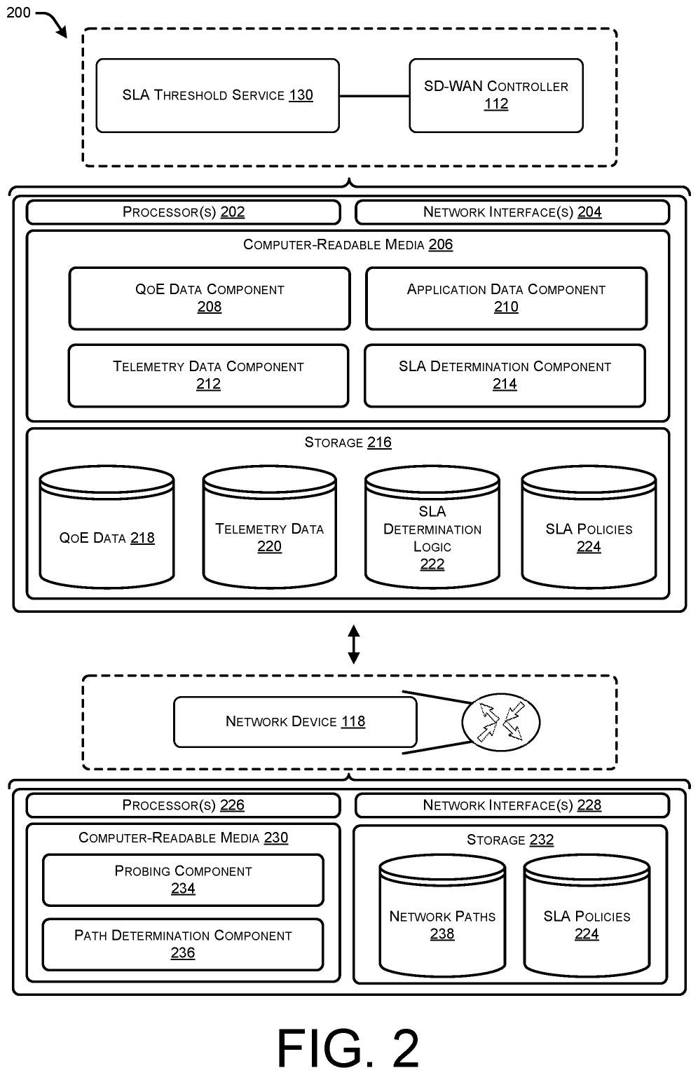

FIG. 2 illustrates an example environment 200 of example components of the SLA threshold service 130 associated with the SD-WAN controller 112 and the network device 118. As illustrated, the SLA threshold service 130 and/or network device 118 may include one or more hardware processor(s) 202 and/or processor(s) 226 (processors) configured to execute one or more stored instructions. The processors 202 may comprise one or more cores. Further, the SLA threshold service 130 may include network interface(s) 204 to allow the processors 202 or other portions of the SLA threshold service 130 to communicate with other devices. The network interface(s) 204 may comprise Inter-Integrated Circuit (I2C), Serial Peripheral Interface bus (SPI), Universal Serial Bus (USB) as promulgated by the USB Implementers Forum, RS-232, and so forth. The network interface(s) 204 may include devices configured to couple to personal area networks (PANs), wired and wireless local area networks (LANs), wired and wireless wide area networks (WANs), and so forth. For example, the network interface(s) 204 may include devices compatible with Ethernet, Wi-Fi™, and so forth.

The SLA threshold service 130 may also include computer-readable media 206 that stores various executable components (e.g., software-based components, firmware-based components, etc.). In addition to various components discussed in FIG. 2, the computer-readable media 206 may further store components to implement functionality described herein. While not illustrated, the computer-readable media 206 may store one or more operating systems utilized to control the operation of the one or more devices that comprise the SLA threshold service 130. The operating systems may implement a variant of the FreeBSD™ operating system as promulgated by the FreeBSD Project; other UNIX™ or UNIX-like variants; a variation of the Linux™ operating system as promulgated by Linus Torvalds; the Windows® Server operating system from Microsoft Corporation of Redmond, Washington, USA; and so forth.

The computer-readable media 206 may include a quality of experience (QoE) data component 208 that configures the SLA threshold service 130 to perform various operations described herein. For instance, the QoE data component may be configured to, when executed by the processors 202, perform various techniques for extracting and/or receiving QoE from third-party service providers and/or applications running on the user device. As described in more detail below with respect to FIG. 3, the QoE data component 208 may utilize data indicating user input indicating a QoE at various instances (e.g., user input and/or feedback indicating the QoE after concluding a video call, where the application is web conferencing application). Additionally, or alternatively, the QoE data component 208 may utilize data extracted by the controller establishing connections (e.g., API calls) with an application. For example, the controller may expose the application interface, and in turn extract QoE data (e.g., indications of response times associated with the application). The computer-readable media 206 may also include a telemetry data component 212 that configures the SLA threshold service 130 to perform various operations described herein. For instance, the telemetry data component 212 may be configured to, when executed by the processors 202, perform various techniques for receiving telemetry data from the network device 118. As described in more detail below with respect to FIG. 3, the telemetry data component 212 may utilize data indicating network performance metrics associated with multiple paths in an SD-WAN, such as traffic loss due to bandwidth constraints, latency, and/or jitter associated with each of the multiple paths. The computer-readable media 206 may also include an application data component 210 that configures the SLA threshold service 130 to perform various operations described herein. For instance, the application data component 210 may be configured to, when executed by the processors 202, perform various techniques for extract and/or receiving application data from the user device, such as user device 102. For example, the application may include an indication of the user device, the site of the application, and/or the like. In this way, the application-specific SLA threshold may additionally, or alternatively, be specific to the user device and/or the site of the application.

The computer-readable media 206 may also include an SLA determination component 214 that configures the SLA threshold service 130 to perform various operations described herein. The SLA determination component 214 may work in conjunction with the QoE data component 208, the telemetry data component 212, and/or the application data component 210 to determine an application-specific SLA threshold. For instance, the QoE data component 208 may extract and/or receive data associated with user input indicating user satisfaction with the application experience (e.g., rating the application experience out of five stars). In another example, the telemetry data component 212 may receive performance metrics associated with multiple paths. The SLA determination component 214 may use, or work in conjunction with, the QoE data component 208 and/or the telemetry data component 212 to determine a suitable SLA threshold for a specific application. Additionally, or alternatively, the SLA determination component 214 may use, or work in conjunction with, the application data component 210 such that the SLA threshold determined by the SLA determination component is specific to a user device and/or site associated with an application sending traffic over the SD-WAN.

Additionally, the SLA threshold service 130 may include which may comprise one, or multiple, repositories or other storage locations for persistently storing and managing collections of data such as databases, simple files, binary, and/or any other data. The storage 216 may include one or more storage locations that may be managed by one or more storage/database management systems. By way of example, and not limitation, computer-readable storage media 216 can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As illustrated, the storage 216 may include QoE data 218, telemetry data 220, SLA determination logic 222, and SLA policies 224. It should be appreciated that the foregoing list is merely exemplary and the storage 216 may include additional elements that may be apparent to one skilled in the art.

The QoE data 218 may include a database of QoE data extracted and/or received from third-party service providers associated with an application. For example, the QoE data 218 may include a record of user input indicating user satisfaction with the application experience (e.g., rating the application experience out of five stars).

Telemetry data 220 may include a database of telemetry data indicating the performance metrics associated with multiple paths in an SD-WAN. For example, the telemetry data 220 may include traffic loss due to bandwidth constraints, latency, and/or jitter associated with each of the multiple paths.

The SLA determination logic 222 may include a database of logic for determining application-specific SLA thresholds. For example, the SLA determination component 214 may reference QoE data 218, telemetry data 220, and/or SLA determination logic 222 in determining an SLA threshold to assign to an application.

The SLA policies 224 may store the results of SLA determination component 214.

Additionally, or alternatively, the SLA policies 224 may include a database formed as a historical compilation of application-specific SLA thresholds.

Further, the network device 118 may include network interface(s) 228 to allow the processors 226 or other portions of the network device 118 to communicate with other devices. The network interface(s) 228 may comprise Inter-Integrated Circuit (I2C), Serial Peripheral Interface bus (SPI), Universal Serial Bus (USB) as promulgated by the USB Implementers Forum, RS-232, and so forth. The network interface(s) 228 may include devices configured to couple to personal area networks (PANs), wired and wireless local area networks (LANs), wired and wireless wide area networks (WANs), and so forth. For example, the network interface(s) 228 may include devices compatible with Ethernet, Wi-Fi™, and so forth.

The network device 118 may also include computer-readable media 230 that stores various executable components (e.g., software-based components, firmware-based components, etc.). In addition to various components discussed in FIG. 2, the computer-readable media 230 may further store components to implement functionality described herein. While not illustrated, the computer-readable media 230 may store one or more operating systems utilized to control the operation of the one or more devices that comprise the SLA threshold service 130. The operating systems may implement a variant of the FreeBSD™ operating system as promulgated by the FreeBSD Project; other UNIX™ or UNIX-like variants; a variation of the Linux™ operating system as promulgated by Linus Torvalds; the Windows® Server operating system from Microsoft Corporation of Redmond, Washington, USA; and so forth.

The computer-readable media 230 may include a probing component 234 that configures the network device 118 to perform various operations described herein. For instance, the probing component 234 may be configured to, when executed by the processors 226, perform various techniques for collecting performance metrics associated with multiple paths of an SD-WAN. In some instances, the probing component 234 may cause the network device 118 to send probes (i.e., synthetic traffic injected along with real network traffic) through the multiple paths in order to collect performance metrics associated with the multiple paths. In some instances, the performance metrics may include a representation of traffic loss due to bandwidth constraints, latency, and jitter associated with each of the multiple paths. In some instances, the network device 118 may passively monitor the multiple paths of an SD-WAN to collect performance metrics associated with the multiple paths.

The computer-readable media 230 may include a path determination component 236 that configures the network device 118 to perform various operations described herein. For instance, the path determination component 236 may be configured to, when executed by the processors 226, perform various techniques for routing application traffic via a path of the SD-WAN based on a policy indicating an application-specific SLA threshold. In some instances, based on the SLA threshold indicated in the policy, the network device 118 may determine a path that would satisfy the SLA threshold for an application. Accordingly, the network device 118 may send application traffic associated with the application over the path that satisfies the SLA threshold.

Additionally, the network device 118 may include storage 232 which may comprise one, or multiple, repositories or other storage locations for persistently storing and managing collections of data such as databases, simple files, binary, and/or any other data. The storage 232 may include one or more storage locations that may be managed by one or more storage/database management systems. By way of example, and not limitation, computer-readable storage media 232 can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As illustrated, the storage 232 may include network paths 238 and SLA policies 224. It should be appreciated that the foregoing list is merely exemplary and the storage 232 may include additional elements that may be apparent to one skilled in the art. The network paths 238 may include a database of multiple network paths in the SD-WAN. SLA policies 224 may include the results of the SLA determination logic 222 received by the network device 118. The SLA policies 224 may store the results of SLA determination component 214.

Additionally, or alternatively, the SLA policies 224 may include a database formed as a historical compilation of application-specific SLA thresholds.

FIG. 3 illustrates an example environment 300 in which an SLA threshold service 130 determines application-specific SLA thresholds. For example, network device 118 may be configured to monitor performance metrics of multiple paths of an SD-WAN and send the performance metrics as telemetry data 304 to SD-WAN controller 112. The device 118 may send telemetry data 304 to the SD-WAN controller 112 periodically or continuously. In some instances, the network device 118 may send probes (i.e., synthetic traffic injected along with real network traffic) through the multiple paths for sending traffic of the SD-WAN in order to collect performance metrics associated with the multiple paths. In some instances, the performance metrics may include a representation of traffic loss due to bandwidth constraints, latency, and jitter associated with each of the multiple paths.

Additionally, or alternatively, the SD-WAN controller 112 may extract and/or receive QoE data 302 from a third-party service provider 108. The SD-WAN controller 112 may receive QoE data 302 directly from the third-party service provider 108 and/or a user of the third-party service associated with the application. For example, a user may provide to the third-party service provider 108 user input indicating a QoE at various instances. As illustrated, user input may include feedback indicating the QoE after a video call, where the user is instructed to rate their satisfaction with their experience out of five stars. Additionally, or alternatively, the SD-WAN controller 112 may establish connections (e.g., API calls) with an application associated with the user. For example, the SD-WAN controller 112 may expose the application interface, and in turn extract QoE data 302 (e.g., indications of response times associated with the application).

Once the SD-WAN controller 112 has received telemetry data 304 and/or QoE data 302, the SLA threshold service 130 may be configured to generate SLA thresholds 308 that are application specific. As illustrated, the SLA threshold service 130 may be configured to collect metrics 306 that are specific to an application. Additionally, or alternatively, the SLA threshold service 130 receive telemetry data 304 with metrics indicating network conditions (e.g., latency, jitter, loss, etc.), and correlate the telemetry data 304 with the QoE data 302 at a particular point in time (e.g., despite inefficient network conditions, QoE may still indicate high performance, and/or vice versa). For example, for a first application, telemetry data 304 may indicate a latency of 100 milliseconds, a jitter of 50 milliseconds, and a loss of 0.1%. Additionally, or alternatively, the SLA threshold service 130 may determine that the QoE of users, based on QoE data 302, was high performing (e.g., above a certain threshold for performance metrics, audio/video quality, user feedback, etc.). Accordingly, the SLA determination component may determine an SLA threshold 308(1) that is specific to the first application. In another example, for a second application, telemetry data 304 may indicate a latency of 200 milliseconds, a jitter of 45 milliseconds, and a loss of 0.05%. Additionally, or alternatively, the SLA threshold service 130 may determine that the QoE of users, based on QoE data 302, was low performing (e.g., below a certain threshold for performance metrics, audio/video quality, user feedback, etc.). Accordingly, the SLA determination component may determine an SLA threshold 308(2) that is specific to the second application. By way of further example, for a third application, telemetry data 304 may indicate a latency of 50 milliseconds, a jitter of 50 milliseconds, and a loss of 0.15%. Additionally, or alternatively, the SLA threshold service 130 may determine that the QoE of users, based on QoE data 302, was “low.” Accordingly, the SLA determination component may determine an SLA threshold 308(3) that is specific to the third application.

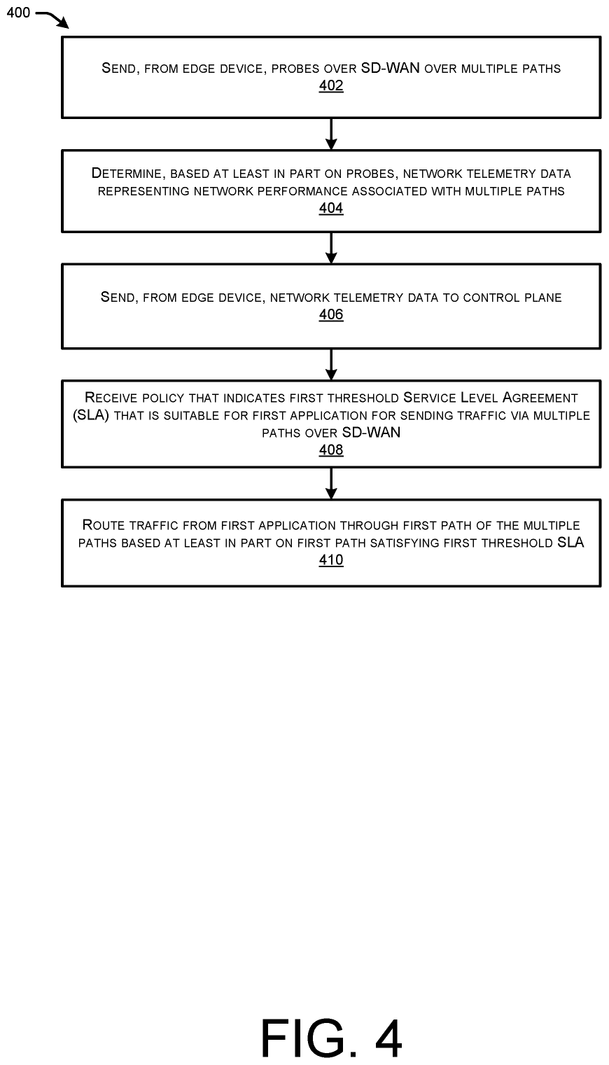

FIG. 4 illustrates a flow diagram of an example process 400 for sending probes over a network to collect telemetry data, and routing application traffic based on an application-specific SLA threshold.

The processes described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, although the processes may be implemented in a wide variety of other environments, architectures and systems.

At block 402, the process 400 may include sending, from the edge device, probes over an SD-WAN over multiple paths. For example, a network edge device may be configured to monitor performance metrics of the SD-WAN and send the performance metrics as telemetry data. The telemetry data may indicate performance metrics for a path. In some instances, the network device may be configured to send the telemetry data to the SD-WAN controller. The network device may send telemetry data periodically or continuously. In some instances, the SD-WAN may include multiple paths for sending traffic for applications. For example, SD-WAN may a first path and/or a second path. The network device may send probes through the first path and/or the second path in order to collect the performance metrics associated with first path and/or second path, respectively.

At block 404, the process 400 may include determining, based at least in part on the probes, network telemetry data representing network performance associated with the multiple paths. For example, based on the probe(s), the network device may determine performance metrics such as traffic loss due to bandwidth constraints, latency in the SD-WAN, and/or jitter. In some instances, the network device may passively monitor paths with probe(s) to collect performance metrics associated with paths. For example, the network device may send probe(s) in response to the SD-WAN controller receiving instructions from a user device for defining an SLA for an application associated with the user device.

At block 406, the process 400 may include sending, from the edge device, network telemetry data to a control plane. In some instances, after the network device has sent probe(s) and has collected performance metrics associated with one or more paths, the network device may be configured to send the performance metrics as telemetry data to the SD-WAN controller. In some instances, the SD-WAN controller may also receive QoE data from third-party service providers. The third-party service providers may be configured to communicate with the SD-WAN controller via network(s). The SD-WAN controller may receive QoE data directly from third-party service providers and/or a user of the third-party service associated with the application. For example, a user associated with an application may provide to the third-party service provider user input indicating a QoE at various instances, where the third-party service provider may be associated with the application. For example, a user may provide user input and/or feedback indicating the QoE after concluding a video call, where the application is a web conferencing application. In another example, the user may provide user input and/or feedback indicating after sending an email, where the application is a messaging application. Additionally, or alternatively, the SD-WAN controller may establish connections (e.g., application programming interface (API) calls) with the application. For example, the SD-WAN controller may expose the application interface, and in turn extract QoE data (e.g., indications of response times associated with the application).

At block 408, the process 400 may include receiving a policy that indicates a first threshold Service Level Agreement (SLA) that is suitable for a first application for sending traffic via the multiple paths over the SD-WAN. For example, the SD-WAN controller may use, or work in conjunction with, SLA threshold service in order to determine an SLA threshold that is specific to an application, such as an SLA threshold that is specific to application and/or an SLA threshold that is specific to application. Additionally, or alternatively, the SLA threshold may be specific to the user device on which the application is running, and/or the site of the application. The SLA threshold may be determined by correlating the telemetry data with QoE data at a particular point in time for a particular application. Additionally, or alternatively, the SLA threshold for an application may be provided as an initial recommendation to a user in response to user instructions for defining the SLA for the application. In some instances, the SLA threshold for an application may be periodically or continuously updated based on changes in network performance metrics indicated by probe(s), and in turn, changes in telemetry data. Additionally, or alternatively, the SLA threshold for an application may be periodically or continuously updated based on changes in the QoE data.

Upon the determination of the SLA threshold that is specific to an application by the SLA threshold service, the SD-WAN controller may be configured to generate an application-aware routing (AAR) policy for routing application traffic for the application, respectively. The policy may be pushed to the network device such that the policy may be enforced, and application traffic may be sent through a path in accordance with their respective SLA threshold.

At block 410, the process 400 may include routing traffic from the first application through a first path of the multiple paths based at least in part on the first path satisfying the first threshold SLA. For example, based on telemetry data and/or QoE data, the SLA threshold service may determine an SLA threshold that is optimized for communicating application traffic from the application. Based on the SLA threshold for the application, the SD-WAN controller may push policy data to the network device indicating the SLA threshold for the application. Based on the SLA threshold for the application, the network device may determine that a certain path would satisfy the SLA threshold for the application. Accordingly, the network device may send application traffic associated with application over the path.

Additionally, or alternatively, based on telemetry data and/or QoE data, the SLA threshold service may determine a different SLA threshold that is optimized for communicating application traffic from the application. Based on the SLA threshold for the application, the SD-WAN controller may push policy data to the network device indicating the SLA threshold for the application. Based on the SLA threshold for the application, the network device may determine that a different path would satisfy the SLA threshold for the application. Accordingly, the network device may send application traffic associated with application over the different path. Additionally, or alternatively, in instances where the SLA threshold may be updated based on changes in the telemetry data and/or QoE data, updated policy data may be pushed to the network device such that the updated policy may be enforced and traffic from the application may be sent through a path in accordance with the updated SLA threshold. For example, based on policy data, the network device may send application traffic associated with application over a path based on the SLA threshold associated with application. Additionally, or alternatively, telemetry data and/or QoE data may change, and as such, the SLA threshold service may determine an updated SLA threshold for the application, and push updated policy data to the network device. In such instances, the network device may cause the application traffic to be sent through a second path instead of a first path based on the first path no longer being able to satisfy the updated SLA value.

Additionally, or alternatively, the process 400 may include receiving the policy that indicates a second threshold Service Level Agreement (SLA) that is suitable for a second application for sending traffic via the multiple paths over the SD-WAN, and routing traffic from the second application through a second path of the multiple paths based at least in part on the second path satisfying the second threshold SLA.

Additionally, or alternatively, the process 400 may include, wherein the network telemetry data is first network telemetry data at a first instance, determining, based at least in part on the probes, second network telemetry data at a second instance representing network performance associated with the multiple paths. Additionally, or alternative, the process 400 may include sending, from the edge device, the second network telemetry data to the control plane, receiving an updated policy that indicates a second threshold Service Level Agreement (SLA) that is suitable for the first application for sending traffic via the multiple paths over the SD-WAN, and routing traffic from the first application through a second path of the multiple paths based at least in part on the second path satisfying the second threshold SLA.

Additionally, or alternatively, the process 400 may include wherein the network telemetry data includes at least one of bandwidth data, traffic loss data, jitter data, and/or latency data.

Additionally, or alternatively, the process 400 may include wherein the first threshold SLA that is suitable for the first application for sending traffic is based at least in part on at least one of the network telemetry data, quality of experience data, and/or a configuration by a user.

Additionally, or alternatively, the process 400 may include receiving a policy that indicates a second threshold SLA that is suitable for a particular device associated with the first application for sending traffic via the multiple paths over the SD-WAN, and routing traffic from first application through a first path of the multiple paths based at least in part on the first path satisfying the second threshold SLA.

Additionally, or alternatively, the process 400 may include receiving a policy that indicates a second threshold SLA that is suitable for a particular location associated with the first application for sending traffic via the multiple paths over the SD-WAN, and routing traffic from the first application through a first path of the multiple paths based at least in part on the first path satisfying the second threshold SLA.

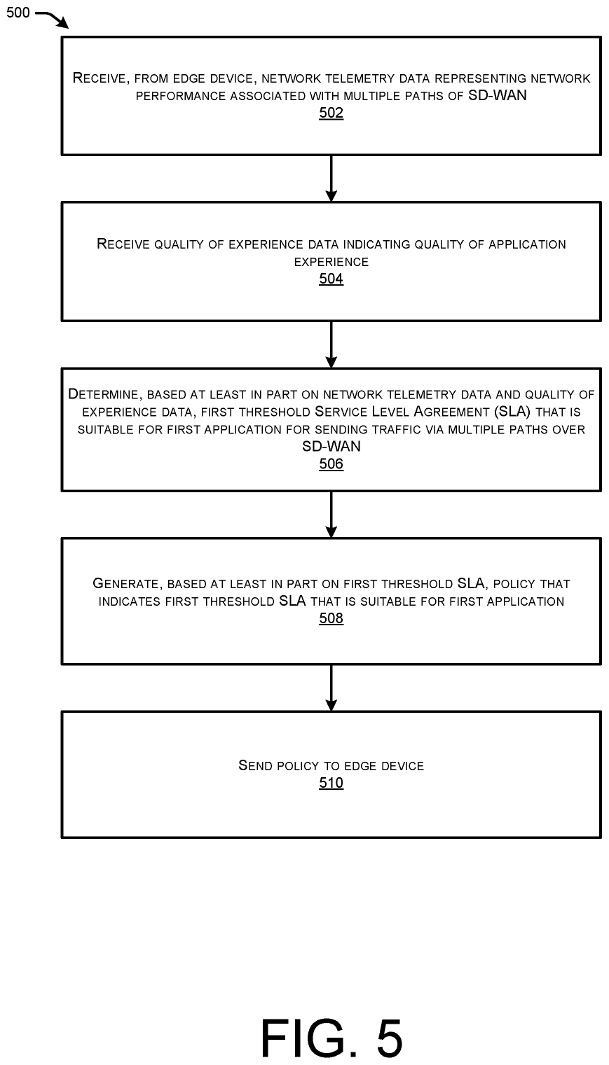

FIG. 5 illustrates a flow diagram of an example process 500 for determining an application-specific SLA threshold. The techniques may be applied by a system comprising one or more processors, and one or more non-transitory computer-readable media storing computer-executable instructions that, when executed by the one or more processors, cause the one or more processors to perform operations of process 500.

At block 502, the process 500 may include receiving, from an edge device, network telemetry data representing network performance associated with multiple paths of an SD-WAN. For example, a network edge device may be configured to monitor performance metrics of the SD-WAN and send the performance metrics as telemetry data. The telemetry data may indicate performance metrics for a path. In some instances, the network device may be configured to send the telemetry data to the SD-WAN controller. The network device may send telemetry data periodically or continuously. In some instances, the SD-WAN may include multiple paths for sending traffic for applications. For example, SD-WAN may a first path and/or a second path. The network device may send probes through the first path and/or the second path in order to collect the performance metrics associated with first path and/or second path, respectively. For example, based on the probe(s), the network device may determine performance metrics such as traffic loss due to bandwidth constraints, latency in the SD-WAN, and/or jitter. In some instances, the network device may passively monitor paths with probe(s) to collect performance metrics associated with paths. For example, the network device may send probe(s) in response to the SD-WAN controller receiving instructions from a user device for defining an SLA for an application associated with the user device. After the network device has sent probe(s) and has collected performance metrics associated with one or more paths, the network device may be configured to send the performance metrics as telemetry data to the SD-WAN controller.

At block 504, the process 500 may include receiving quality of experience data indicating a quality of application experience. In some instances, the SD-WAN controller may also receive QoE data from third-party service providers. The third-party service providers may be configured to communicate with the SD-WAN controller via network(s). The SD-WAN controller may receive QoE data directly from third-party service providers and/or a user of the third-party service associated with the application. For example, a user associated with an application may provide to the third-party service provider user input indicating a QoE at various instances, where the third-party service provider may be associated with the application. For example, a user may provide user input and/or feedback indicating the QoE after concluding a video call, where the application is a web conferencing application. In another example, the user may provide user input and/or feedback indicating after sending an email, where the application is a messaging application. Additionally, or alternatively, the SD-WAN controller may establish connections (e.g., application programming interface (API) calls) with the application. For example, the SD-WAN controller may expose the application interface, and in turn extract QoE data (e.g., indications of response times associated with the application).

At block 506, the process 500 may include determining, based on the network telemetry data and the quality of experience data, a first threshold Service Level Agreement (SLA) that is suitable for a first application for sending traffic via the multiple paths over the SD-WAN. For example, the SD-WAN controller may use, or work in conjunction with, SLA threshold service in order to determine an SLA threshold that is specific to an application, such as an SLA threshold that is specific to application and/or an SLA threshold that is specific to application. Additionally, or alternatively, the SLA threshold may be specific to the user device on which the application is running, and/or the site of the application. The SLA threshold may be determined by correlating the telemetry data with QoE data at a particular point in time for a particular application. Additionally, or alternatively, the SLA threshold for an application may be provided as an initial recommendation to a user in response to user instructions for defining the SLA for the application. In some instances, the SLA threshold for an application may be periodically or continuously updated based on changes in network performance metrics indicated by probe(s), and in turn, changes in telemetry data. Additionally, or alternatively, the SLA threshold for an application may be periodically or continuously updated based on changes in the QoE data.

At block 508, the process 500 may include generating, based at least in part on the first threshold SLA, a policy that indicates the first threshold SLA that is suitable for the first application. In some instances, upon the determination of the SLA threshold that is specific to an application by the SLA threshold service, the SD-WAN controller may be configured to generate an application-aware routing (AAR) policy for routing application traffic for the application, respectively. The policy may be pushed to the network device such that the policy may be enforced, and application traffic may be sent through a path in accordance with their respective SLA threshold.

At block 510, the process 500 may include sending the policy to the edge device.

Additionally, or alternatively, the process 500 may include determining, based at least in part on the network telemetry data and the quality of experience data, a second threshold SLA that is suitable for a second application for sending traffic via the multiple paths over the SD-WAN, generating, based at least in part on the second threshold SLA, a policy that indicates the second threshold SLA that is suitable for the second application, and sending the policy to the edge device.

Additionally, or alternatively, the process 500 may include, wherein the network telemetry data is first network telemetry data at a first instance and the quality of experience data is first quality of experience data at the first instance, receiving, from the edge device, second network telemetry data at a second instance representing network performance associated with multiple paths of an SD-WAN and receiving second quality of experience data at the second instance indicating a quality of application experience. Additionally, or alternatively, the process 500 may include determining, based at least in part on the second network telemetry data and second quality of experience data, a second threshold Service Level Agreement (SLA) that is suitable for a first application for sending traffic via the multiple paths over the SD-WAN, generating, based at least in part on the second threshold SLA, an updated policy that indicates the second threshold SLA that is suitable for the first application instead of the first threshold SLA, and sending the updated policy to the edge device.

Additionally, or alternatively, the process 500 may include wherein the network telemetry data includes at least one of bandwidth data, traffic loss data, jitter data, and/or latency data.

Additionally, or alternatively, the process 500 may include determining, based at least in part on the network telemetry data and the quality of experience data, a second threshold Service Level Agreement (SLA) that is suitable for a particular device associated with the first application for sending traffic via the multiple paths over the SD-WAN, generating, based at least in part on the second threshold SLA, a policy that indicates the second threshold SLA that is suitable for the particular device associated with the first application, and sending the policy to the edge device.

Additionally, or alternatively, the process 500 may include determining, based at least in part on the network telemetry data and the quality of experience data, a second threshold Service Level Agreement (SLA) that is suitable for a particular location associated with the first application for sending traffic via the multiple paths over the SD-WAN, generating, based at least in part on the second threshold SLA, a policy that indicates the second threshold SLA that is suitable for the particular location associated with the first application, and sending the policy to the edge device.

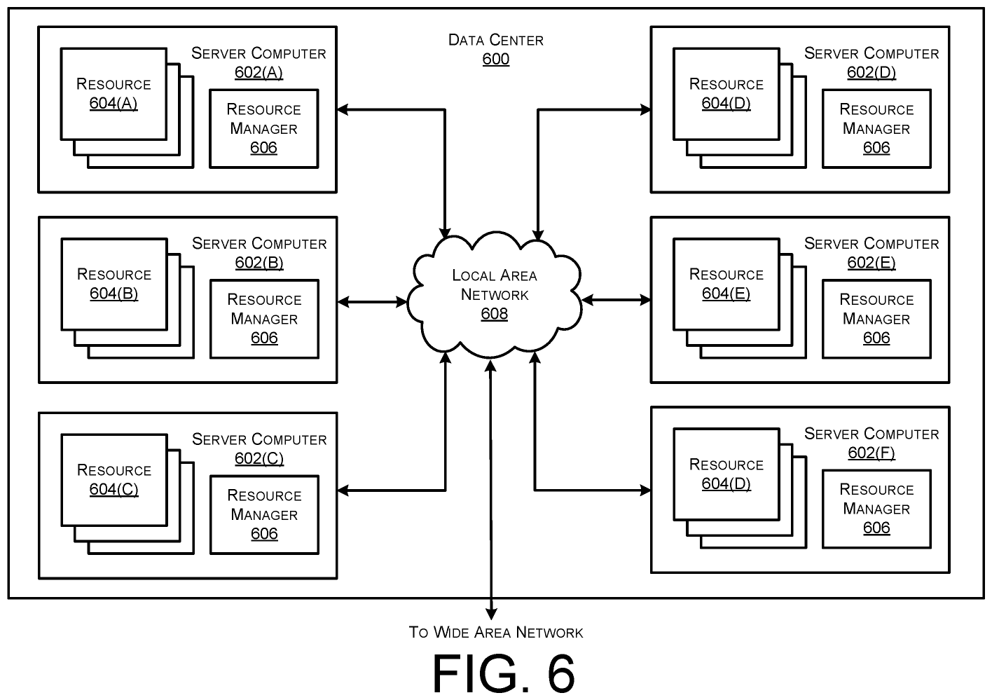

FIG. 6 is a computing system diagram illustrating a configuration for a data center 600 that can be utilized to implement aspects of the technologies disclosed herein. In one example, the data center 600 may be used to support the SLA threshold service 130 and/or the network device 118. The example data center 600 shown in FIG. 6 includes several server computers 602A-602F (which might be referred to herein singularly as “a server computer 602” or in the plural as “the server computers 602”) for providing computing resources. In some examples, the resources and/or server computers 602 may include, or correspond to, the any type of networked device described herein. Although described as servers, the server computers 602 may comprise any type of networked device, such as servers, switches, routers, hubs, bridges, gateways, modems, repeaters, access points, etc.

The server computers 602 can be standard tower, rack-mount, or blade server computers configured appropriately for providing computing resources. In some examples, the server computers 602 may provide computing resources 604 including data processing resources such as VM instances or hardware computing systems, database clusters, computing clusters, storage clusters, data storage resources, database resources, networking resources, and others. Some of the servers 602 can also be configured to execute a resource manager 606 capable of instantiating and/or managing the computing resources. In the case of VM instances, for example, the resource manager 606 can be a hypervisor or another type of program configured to enable the execution of multiple VM instances on a single server computer 602. Server computers 602 in the data center 600 can also be configured to provide network services and other types of services. In one example, server computers 602 may be used to support the SLA threshold service 130 and/or the cloud service 132.

In the example data center 600 shown in FIG. 6, an appropriate LAN 608 is also utilized to interconnect the server computers 602A-602F. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers 600, between each of the server computers 602A-602F in each data center 600, and, potentially, between computing resources in each of the server computers 602. It should be appreciated that the configuration of the data center 600 described with reference to FIG. 6 is merely illustrative and that other implementations can be utilized.

In some examples, the server computers 602 may each execute one or more application containers and/or virtual machines to perform techniques described herein.

In some instances, the data center 600 may provide computing resources, like application containers, VM instances, and storage, on a permanent or an as-needed basis. Among other types of functionality, the computing resources provided by a cloud computing network may be utilized to implement the various services and techniques described above. The computing resources 604 provided by the cloud computing network can include various types of computing resources, such as data processing resources like application containers and VM instances, data storage resources, networking resources, data communication resources, network services, and the like.

Each type of computing resource 604 provided by the cloud computing network can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The cloud computing network can also be configured to provide other types of computing resources 604 not mentioned specifically herein.

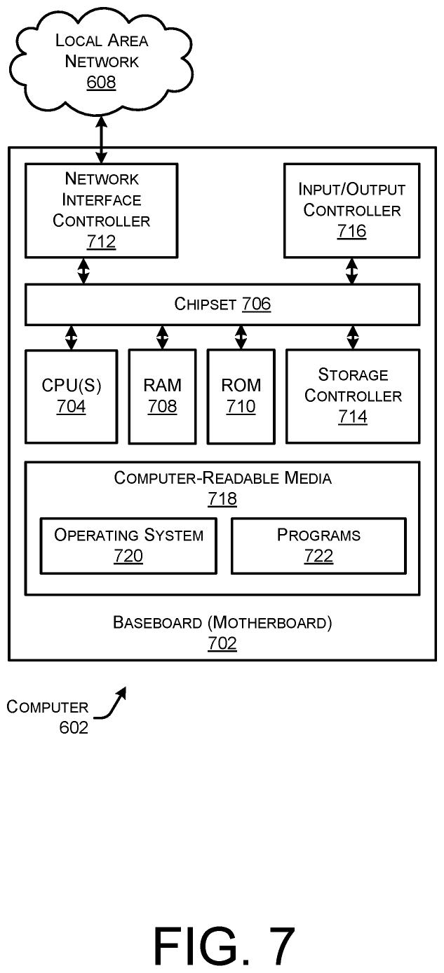

The computing resources 604 provided by a cloud computing network may be enabled in one embodiment by one or more data centers 600 (which might be referred to herein singularly as “a data center 600” or in the plural as “the data centers 600”). The data centers 600 are facilities utilized to house and operate computer systems and associated components. The data centers 600 typically include redundant and backup power, communications, cooling, and security systems. The data centers 600 can also be located in geographically disparate locations. One illustrative embodiment for a data center 600 that can be utilized to implement the technologies disclosed herein will be described below with regard to FIG. 7.

FIG. 7 shows an example computer architecture for a server computer 602 capable of executing program components for implementing the functionality described above. The computer architecture shown in FIG. 7 illustrates a conventional server computer, workstation, desktop computer, laptop, tablet, network appliance, e-reader, smartphone, or other computing device, and can be utilized to execute any of the software components presented herein. The server computer 602 may, in some examples, correspond to a physical server and may comprise networked devices such as servers, switches, routers, hubs, bridges, gateways, modems, repeaters, access points, etc.

The computer 602 includes a baseboard 702, or “motherboard,” which is a printed circuit board to which a multitude of components or devices can be connected by way of a system bus or other electrical communication paths. In one illustrative configuration, one or more central processing units (“CPUs”) 704 operate in conjunction with a chipset 706. The CPUs 704 can be standard programmable processors that perform arithmetic and logical operations necessary for the operation of the computer 602.

The CPUs 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 706 provides an interface between the CPUs 704 and the remainder of the components and devices on the baseboard 702. The chipset 706 can provide an interface to a RAM 708, used as the main memory in the computer 602. The chipset 706 can further provide an interface to a computer-readable storage medium such as a read-only memory (“ROM”) 710 or non-volatile RAM (“NVRAM”) for storing basic routines that help to start up the computer 602 and to transfer information between the various components and devices. The ROM 710 or NVRAM can also store other software components necessary for the operation of the computer 602 in accordance with the configurations described herein.

The computer 602 can operate in a networked environment using logical connections to remote computing devices and computer systems through a network, such as the network 608. The chipset 706 can include functionality for providing network connectivity through a NIC 712, such as a gigabit Ethernet adapter. The NIC 712 is capable of connecting the computer 602 to other computing devices over the network 608. It should be appreciated that multiple NICs 712 can be present in the computer 602, connecting the computer to other types of networks and remote computer systems.

The computer 602 can be connected to a storage device 718 that provides non-volatile storage for the computer. The storage device 718 can store an operating system 720, programs 722, and data, which have been described in greater detail herein. The storage device 718 can be connected to the computer 602 through a storage controller 714 connected to the chipset 706. The storage device 718 can consist of one or more physical storage units. The storage controller 714 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 602 can store data on the storage device 718 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 718 is characterized as primary or secondary storage, and the like.

For example, the computer 602 can store information to the storage device 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 602 can further read information from the storage device 718 by detecting the physical states or characteristics of one or more particular locations within the physical storage units.

In addition to the mass storage device 718 described above, the computer 602 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 602. In some examples, the operations performed by devices in the cloud service 132, and or any components included therein, may be supported by one or more devices similar to computer 602. Stated otherwise, some or all of the operations performed by the cloud service 132, and or any components included therein, may be performed by one or more computer devices 602 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 718 can store an operating system 720 utilized to control the operation of the computer 602. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 718 can store other system or application programs and data utilized by the computer 602.

In one embodiment, the storage device 718 or other computer-readable storage media is encoded with computer-executable instructions which, when loaded into the computer 602, transform the computer from a general-purpose computing system into a special-purpose computer capable of implementing the embodiments described herein. These computer-executable instructions transform the computer 602 by specifying how the CPUs 704 transition between states, as described above. According to one embodiment, the computer 602 has access to computer-readable storage media storing computer-executable instructions which, when executed by the computer 602, perform the various processes described above with regard to FIGS. 1-6. The computer 602 can also include computer-readable storage media having instructions stored thereupon for performing any of the other computer-implemented operations described herein.

The computer 602 can also include one or more input/output controllers 716 for receiving and processing input from a number of input devices, such as a keyboard, a mouse, a touchpad, a touch screen, an electronic stylus, or other type of input device. Similarly, an input/output controller 716 can provide output to a display, such as a computer monitor, a flat-panel display, a digital projector, a printer, or other type of output device. It will be appreciated that the computer 602 might not include all of the components shown in FIG. 7, can include other components that are not explicitly shown in FIG. 7, or might utilize an architecture completely different than that shown in FIG. 7.

As described herein, the computer 602 may comprise one or more of a router, load balancer, and/or server. The computer 602 may include one or more hardware processors 704 (processors) configured to execute one or more stored instructions. The processor(s) 704 may comprise one or more cores. Further, the computer 602 may include one or more network interfaces configured to provide communications between the computer 602 and other devices, such as the communications described herein as being performed by the router, load balancer, and/or server. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 722 may comprise any type of programs or processes to perform the techniques described in this disclosure for prioritizing the scanning of incoming messages based on an account status and/or an activity pattern associated with the account receiving the message. That is, the computer 602 may comprise any one of the routers, load balancers, and/or servers. The programs 722 may comprise any type of program that cause the computer 602 to perform techniques for communicating with other devices using any type of protocol or standard usable for determining connectivity.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method performed at least in part by an edge device, the method comprising:
sending, from the edge device, probes over an SD-WAN over multiple paths;
determining, based at least in part on the probes, network telemetry data representing network performance associated with the multiple paths;
sending, from the edge device, network telemetry data to a control plane;
receiving a policy that indicates a first threshold Service Level Agreement (SLA) that is suitable for a first application for sending traffic via the multiple paths over the SD-WAN; and
routing traffic from the first application through a first path of the multiple paths based at least in part on the first path satisfying the first threshold SLA.

2. The method of claim 1, further comprising:
receiving the policy that indicates a second threshold Service Level Agreement (SLA) that is suitable for a second application for sending traffic via the multiple paths over the SD-WAN; and
routing traffic from the second application through a second path of the multiple paths based at least in part on the second path satisfying the second threshold SLA.

3. The method of claim 1, wherein the network telemetry data is first network telemetry data at a first instance, the method further comprising:
determining, based at least in part on the probes, second network telemetry data at a second instance representing network performance associated with the multiple paths;
sending, from the edge device, the second network telemetry data to the control plane;
receiving an updated policy that indicates a second threshold Service Level Agreement (SLA) that is suitable for the first application for sending traffic via the multiple paths over the SD-WAN; and
routing traffic from the first application through a second path of the multiple paths based at least in part on the second path satisfying the second threshold SLA.

4. The method of claim 1, wherein the network telemetry data includes at least one of:
bandwidth data;
traffic loss data;
jitter data; or
latency data.

5. The method of claim 1, wherein the first threshold SLA that is suitable for the first application for sending traffic is based at least in part on at least one of:
the network telemetry data;
quality of experience data; or
a configuration by a user.

6. The method of claim 1, further comprising:
receiving a policy that indicates a second threshold SLA that is suitable for a particular device associated with the first application for sending traffic via the multiple paths over the SD-WAN; and
routing traffic from first application through a first path of the multiple paths based at least in part on the first path satisfying the second threshold SLA.

7. The method of claim 1, further comprising:
receiving a policy that indicates a second threshold SLA that is suitable for a particular location associated with the first application for sending traffic via the multiple paths over the SD-WAN; and
routing traffic from the first application through a first path of the multiple paths based at least in part on the first path satisfying the second threshold SLA.

8. A system comprising:
one or more processors; and
one or more computer-readable media storing computer-executable instructions that, when executed by the one or more processors, cause the one or more processors to perform operations comprising:
sending, from an edge device, probes over an SD-WAN over multiple paths;
determining, based at least in part on the probes, network telemetry data representing network performance associated with the multiple paths;
sending, from the edge device, network telemetry data to a control plane;
receiving a policy that indicates a first threshold Service Level Agreement (SLA) that is suitable for a first application for sending traffic via the multiple paths over the SD-WAN; and
routing traffic from the first application through a first path of the multiple paths based at least in part on the first path satisfying the first threshold SLA.

9. The system of claim 8, the operations further comprising:
receiving the policy that indicates a second threshold Service Level Agreement (SLA) that is suitable for a second application for sending traffic via the multiple paths over the SD-WAN; and
routing traffic from the second application through a second path of the multiple paths based at least in part on the second path satisfying the second threshold SLA.

10. The system of claim 8, wherein the network telemetry data is first network telemetry data at a first instance, the operations further comprising:
determining, based at least in part on the probes, second network telemetry data at a second instance representing network performance associated with the multiple paths;
sending, from the edge device, the second network telemetry data to the control plane;
receiving an updated policy that indicates a second threshold Service Level Agreement (SLA) that is suitable for the first application for sending traffic via the multiple paths over the SD-WAN; and
routing traffic from the first application through a second path of the multiple paths based at least in part on the second path satisfying the second threshold SLA.

11. The system of claim 8, wherein the network telemetry data includes at least one of:
bandwidth data;
traffic loss data;
jitter data; or
latency data.

12. The system of claim 8, wherein the first threshold SLA that is suitable for the first application for sending traffic is based at least in part on at least one of:
the network telemetry data;
quality of experience data; or
a configuration by a user.

13. The system of claim 8, the operations further comprising:
receiving a policy that indicates a second threshold SLA that is suitable for a particular device associated with the first application for sending traffic via the multiple paths over the SD-WAN; and
routing traffic from the first application through a first path of the multiple paths based at least in part on the first path satisfying the second threshold SLA.

14. The system of claim 8, the operations further comprising:
receiving a policy that indicates a second threshold SLA that is suitable for a particular location associated with the first application for sending traffic via the multiple paths over the SD-WAN; and
routing traffic from the first application through a first path of the multiple paths based at least in part on the first path satisfying the second threshold SLA.

15. One or more non-transitory computer-readable media storing instructions that, when executed, cause one or more processors to perform operations comprising:
receiving, from an edge device, network telemetry data representing network performance associated with multiple paths of an SD-WAN;
receiving quality of experience data indicating a quality of application experience;
determining, based at least in part on the network telemetry data and the quality of experience data, a first threshold Service Level Agreement (SLA) that is suitable for a first application for sending traffic via the multiple paths over the SD-WAN;
generating, based at least in part on the first threshold SLA, a policy that indicates the first threshold SLA that is suitable for the first application; and
sending the policy to the edge device.

16. The one or more non-transitory computer-readable media of claim 15, the operations further comprising:
determining, based at least in part on the network telemetry data and the quality of experience data, a second threshold SLA that is suitable for a second application for sending traffic via the multiple paths over the SD-WAN;
generating, based at least in part on the second threshold SLA, a policy that indicates the second threshold SLA that is suitable for the second application; and
sending the policy to the edge device.

17. The one or more non-transitory computer-readable media of claim 15, wherein the network telemetry data is first network telemetry data at a first instance, the quality of experience data is first quality of experience data at the first instance, the operations further comprising:
receiving, from the edge device, second network telemetry data at a second instance representing network performance associated with multiple paths of an SD-WAN;
receiving second quality of experience data at the second instance indicating a quality of application experience;
determining, based at least in part on the second network telemetry data and second quality of experience data, a second threshold Service Level Agreement (SLA) that is suitable for a first application for sending traffic via the multiple paths over the SD-WAN;
generating, based at least in part on the second threshold SLA, an updated policy that indicates the second threshold SLA that is suitable for the first application instead of the first threshold SLA; and
sending the updated policy to the edge device.

18. The one or more non-transitory computer-readable media of claim 15, wherein the network telemetry data includes at least one of:
bandwidth data;
traffic loss data;
jitter data; or
latency data.

19. The one or more non-transitory computer-readable media of claim 15, the operations further comprising:
determining, based at least in part on the network telemetry data and the quality of experience data, a second threshold Service Level Agreement (SLA) that is suitable for a particular device associated with the first application for sending traffic via the multiple paths over the SD-WAN;
generating, based at least in part on the second threshold SLA, a policy that indicates the second threshold SLA that is suitable for the particular device associated with the first application; and
sending the policy to the edge device.

20. The one or more non-transitory computer-readable media of claim 15, the operations further comprising:
determining, based at least in part on the network telemetry data and the quality of experience data, a second threshold Service Level Agreement (SLA) that is suitable for a particular location associated with the first application for sending traffic via the multiple paths over the SD-WAN;
generating, based at least in part on the second threshold SLA, a policy that indicates the second threshold SLA that is suitable for the particular location associated with the first application; and
sending the policy to the edge device.
